(19) United States
(12) Patent Application Publication
(10) Pub. No.: US 2007/0156555 A1
(43) Pub. Date: Jul. 5, 2007

(54) Systems, methods and programs for determining optimal financial structures and risk exposures

(76) Inventor: Peter C. Orr, New York, NY (US)

Correspondence Address: Peter C. Orr, Suite 1G, 138 Broadway, New York, NY, 11211, US

(21) Appl. No.: 11/640,010

(22) Filed: Dec. 15, 2006

Related U.S. Application Data
(60) Provisional application No. 60/751,504, filed on Dec. 17, 2005.

(51) Int. Cl. G06Q 40/00

(52) U.S. Cl. 705/35

(57) ABSTRACT

A model for analyzing a cashflow sensitive instrument is described that uses an optimization model of a data set associated with a cashflow sensitive instrument, which optimization model is based at least in part on an interest rate model and a cash-flow model. The interest rate model is at least partially based on at least one random variable used to simulate an underlying distribution on at least one interest rate. A model output is then generated based on the optimization model. The model outputs all optimal cashflow solution for the cashflow sensitive instrument(s) that at least partially optimizes factors of risk and/or cost. Related methods, programs and systems are also provided.

The present Utility patent application claims priority benefit of the U.S. provisional application for patent No. 60/751,504 filed on Dec. 17, 2005 under 35 U.S.C. 119(e). The contents of this related provisioinal application are incorporated herein by

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the paten t document or patent disclosure as it appears in the Patent and Trademark Office, patent file or records, but otherwise reserves all copyright rights whatsoever.

### FIELD OF THE INVENTION

The present invention is related to asset/liability management of capital market risks. More particularly the invention is related to a method for determining optimal derivative structures and risk exposures given a combination of current market data, market forecasts, and structure constraints, specifically for entities managing capital market risks.

### BACKGROUND OF THE INVENTION

Traditional finance theory dating, to Harry Markowitz and his 1952 paper “Portfolio Selection” has in the main considered risk to be reflected in the price volatility of financial instruments and securities. This view has persisted remarkably well into the present day. In the 1980s and 1990s with the proliferation of derivatives and structured products, there was a general sense that asset/liability management techniques needed to be improved since standard earnings and net interest calculations could be too easily manipulated by the new innovations. A renewed emphasis on mark to market valuation and risk emerged. Till Guldimann, the architect of RiskMetrics within JP Morgan, in the 1994 first RiskMetrics Technical Document states:
“Across markets, traded securities have replaced many illiquid instruments, e.g., loans and mortgages have been securlitized to permit disintermediation and trading. Global securities markets have expanded and both exchange traded and over-the-counter derivatives have become major components of the markets.
These developments, along with technological breakthroughs in data processing, have gone hand in hand with changes in management practices: a movement away from management bases on accrual accounting toward risk management based on marking to market of positions”

The Basel Accords formalized this viewpoint for banks with 10 day Value at Risk (VAR) calculations serving as the cornerstone for measuring market risk related bank capital requirements. As expected, the financial engineering and quantitative finance communities focused intently on refining mark to market and VaR risk metrics for a multitude of new instruments; credit derivatives, asset backed securities, exotic interest rate derivatives, structured currency transactions, total return swaps, commodity swaps and options, among many other innovations.

Even more recently in 2001, RiskMetrics in its RiskGrades Technical Document, a product for individual investors, states, “You would expect cash to have a RiskGrade value of zero, while a technology IPO may have a RiskGrade value exceeding 1000.” Many individual investors, particularly those with relatively fixed liabilities (mortgage, car, medication, and insurance payments), would not agree that the varying nominal return on cash, or more precisely, money market funds warrant a zero risk assessment. This would be akin to suggesting that an adjustable rate mortgage is zero risk as well because the value of the mortgage is always the same.

As a result, with the great energy put forth understanding this pervasive mark to market perspective on risk, relatively little effort has been spent developing quantitative models that view risk from the perspective of cash flow volatility or variability. Cash flow volatility is often of paramount concern to a large cross section of economic actors including, individual consumers, for profit and not-for-profit corporations, and states, cities, counties and other local and municipal governments.

Looking at a clarifying, example, in contrast to interest rate risk metrics for fixed income portfolio managers such as duration, convexity, present value of a basis point, PV01, and DV01 which are driven by the need to analyze potential portfolio price volatility, many corporate fiance managers primarily view risk for these same types of instruments in terms of cash flow volatility. A floating rate bond for instance, which is deemed to have nearly zero risk to a portfolio manager or investor due to its par (or near par) price, is the most risky instrument to a liability manager because she/he must pay an uncertain, volatile and potentially very high floating rate of interest to service the debt. It is for these reasons that the prime measure of cash flow risk in the corporate finance markets is the current ratio of floating and fixed rate debt, the so-called “fixed/floating mix.” This term is quite common in discussions with ratings and credit analysts, treasurers, CFOs, finance committees, and corporate board members.

This situation as well as shortcomings of the fixed/floating mix was detailed recently by JP Morgan. An October, 2004 article published by JP Morgan called Beyond Fixed Floating: Introducing a Dollar Based Risk Metric for Municipal Finance, describes this measure and its limitations.

Interest rate models and market diffusion models more generally have been absent from the vast majority of the discussion for cash flow sensitive entities listed above, in part because of the perceived complexity of these models coupled with a misunderstanding of their application. This is at least one likely explanation for why the fixed/floating mix has prevailed as a risk measure despite the availability of more powerful and meaningful alternatives. As a current ratio, fixed/floating mix is a metric that is at best marginally useful in structuring risk exposures, if at all.

The pervasive mark to market view of risk brings with it an additional important implication. Traditional finance literature teaches that it in order to arrive at propel asset pricing methodologies one must adopt a no-arbitrage or “risk-neutral” view of the world. Although classic theoretical construction requires this by definition, no-arbitrage or “implied” market rates and prices have not proven to be accurate predictors of future market rates or price levels and for good reasons not explored here. There is a very real need for better analysis of arbitrage-rich or “real world” views of the future for the following reason: the perspective of an economic agent who solely uses no-arbitrage models in risk assessment is almost by definition joined to one who has a mark to market view of risk or engages in a trading business. For example, an asset manager or derivatives trader whose portfolio is marked to market daily at an insurance company, mutual fund, hedge fluid, bank, or broker/dealer must use these no-arbitrage models. That is, for an entity whose business is trading financial instruments, no arbitrage models are absolutely appropriate, even essential. However, for those economic actors who intend to assume or shed a risk exposure over a long and perhaps indefinite horizon, the risk perspective changes to one where no-arbitrage models may no longer be optimal or even appropriate. This is an extremely important dimension of difference between the viewpoints of those who look at risk from a mark to market perspective versus a cash flow one. The risk perspective carries with it a horizon or holding period implication; very short or daily for the agent looking at mark to market risk and very long for those looking at risk from a cash flow, accrual, or earnings perspective.

As a result, the horizons contemplated by available capital market risk management software are usually too short for evaluating long term risk positions. By virtue of many individuals and particularly public corporations fundamental nature as going concerns, they often have very long term horizons, and must manage risk accordingly. The J P Morgan article referenced above, Beyond Fixed Floating: Introducing a Dollar Based Risk Metric for Municipal Finance, describes this phenomenon in the public finance sector as well. Many available analytic tools such as the products available from RiskMetrics are not designed for 10+ year's analysis and in fact, their documentation says as much. In the LongRun technical document on pg 3, “Whereas the RiskMetrics methodology is geared toward measuring market risks for short-term horizons, up to approximately 3 months, LongRun handles longer-term market risk up to 2 years.” Two years is not a time horizon sufficient for individuals or corporations making capital market decisions with decade long horizons or longer.

Additionally, products like those RiskMetrics offers provide no explicit financial structuring capability on the liability side, and even if they did, they would not be relevant due to the horizon limitation mentioned above.

Available software such as Palisade's RISKOptimizer is advertised to marry monte carlo simulation with optimization methods. However, these types of generic packages do not have any of the financial functions required to generate cash flows from a wide array of financial instruments, and ultimately do not recognize the element of risk critical for constructing the problem in the first instance: If even possible, it would take significant effort to build the requisite financial functionality into these types of generic tools.

Using diffusion models to simulate market variables in order to generate distributions of possible financial outcomes has been used in many contexts including risk metrics, asset pricing, stress testing, and portfolio optimization. For example, the RiskMetrics product Corporate Manager calculates Earnings-at-Risk and Cash Flows-at-Risk statistics in order to assess earnings and cash flow risk exposures. Details on various methods for simulating market risk elements can be bound in the associated RiskMetrics Technical Documents.

Background for the invention involves using an interest rate model to diffuse at least one interest rate into the future. Information on interest rate modeling can be found in many texts and publications including the RiskMertcs document mentioned above, Interest Rate Option Models by Ricardo Rebonato, and Monte Carlo Methods in Financial Engineering by Paul Glasserman.

Optimization methods are also used in the present invention. Background on optimization can be found in a variety of texts including the Optimization Toolbox (Version 3) For Use with MATLAB, Practical Methods of Optimization by Fletcher, and Introduction to Stochastic Search and Optimization by Spall.

In view of the foregoing, there is a need for a method for determining optimal financial structures ad risk exposures in the context of a cash flow risk perspective.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows exemplary equipment that may enable a user to employ the optimal derivative structure and risk determining method, in accordance with an embodiment of the present invention;

FIG. 2 is a flowchart illustrating exemplary steps for the optimal derivative structure and risk determining method, in accordance with an embodiment of the present invention:

FIGS. 3 through 5 illustrate exemplary simulations of different rates in graph form and as average rates, in accordance with an embodiment of the present invention. FIG. 3 shows Bond Market Association Municipal Swap Index (“BMA”) simulated semi-annually over 20 years. FIG. 4 shows an average of the BMA divided by the London Inter-bank Offered Rate (“LIBOR”) (the “BMA/LIBOR ratio”) modeled over the same time frame. The BMA rates in FIG. 3 divided by the BMA/LIBOR ratios in FIG. 4 yield the simulation for LIBOR itself shown in FIG. 5;

FIGS. 6 through 8 illustrate three-dimensional matrixes for a number of different exemplary simulations, in accordance with an embodiment of the present

FIG. 6a shows an exemplary representation of a 3 dimensional matrix of (rows X columns X panels) time steps X number of simulations X number of market variables, called “M”. FIG. 6b shows a 3 dimensional matrix of time steps X number of simulations X functions of market elements representing financial instruments such as derivatives, investments, or assets, called “f” or “f(M)” throughout this disclosure, in accordance with an embodiment of the present invention;

FIG. 7a shows an exemplary representation of a 3 dimensional matrix of time steps X number of simulations X notional amounts of bonds or derivatives, called “N” throughout this disclosure. FIG. 7b shows a 3 dimensional matrix of time steps X number of simulations X time increments in years, called “t” throughout this disclosure.

FIG. 8a shows an exemplary representation of a 3 dimensional matrix of time steps X number of simulations X cashflows for each structure, called “C” or “Ct” throughout this disclosure, in accordance with an embodiment of the present invention;

FIG. 8b shows an exemplary 3 dimensional matrix of time steps X number of simulations X principal payments on bonds in number of market elements, called “P” throughout this disclosure in accordance with an embodiment of the present invention;

FIG. 9 illustrates graphically an exemplary minimization of an exemplary function, g(x), by changing an input scalar, vector, or matrix, x, to find the minimum, g′(x) at x′, in accordance with an embodiment of the present invention;

FIGS. 10 through 13 illustrate exemplary information for tile following example calculations, in accordance with an embodiment of the present invention. FIG. 10 shows an exemplary table of coupon rates and principal amounts for hypothetical bonds issued on Jan. 1, 2005. FIG. 11 shows the annual principal and interest payments required to pay off $100 million in bonds at tile coupon rates shown in FIG. 10. FIG. 12 shows the annual principal and interest payments from FIG. 11 net of the earnings from $10 million in cash, assumed to earn LIBOR, a short term modeled rate. FIG. 13 shows the annual principal and interest payments from FIG. 12 after adding a BMA based swap to floating in the amount of $14.19 million.

Unless otherwise indicated illustrations in the figures are not necessarily drawn to scale.

### SUMMARY OF THE INVENTION

To achieve the forgoing and other objects and in accordance with the purpose of the invention, a variety of techniques for determining optimal derivative structures and risk exposures are described. In an embodiment of the present invention, a model is provided for analyzing a cashflow sensitive instrument that uses an optimization model of a data set associated with a cashflow sensitive instrument, which optimization model is based at least ii part on an interest rate model and a cash-flow model. The interest rate model of at embodiment is at least partially based on at least one random variable used to simulate an underlying distribution of at least one interest rate. A model output of an embodiment then generated based on the optimization model. In an embodiment, the model output outputs an optimal cashflow solution for the cashflow sensitive instrument(s) that is at least partially optimizes for the factors of risk and/or cost.

An aspect of at least some embodiments of the present invention is to provide a method for determining, optimal derivative structures and risk exposures given a combination of current market data, market forecasts, and structure constraints. The system then uses this information plus explicit user provided parameters, including at least one short-term interest rate, to form distributions of market variables. This single or multivariate distribution then forms the basis for minimizing measures of expected cost and/or meaningful measures of expected cash flow risk. In this way, not only is an alternative to the fixed/floating metric created, but these metrics are then employed within a consistent, coherent quantitative framework for determining one or more optimal exposures throughout any selected horizon or across multiple horizons.

An aspect of at least some embodiments of the invention is to determine optimal risk exposures that are derived at least in part by expected cash flow magnitude and cash flow risk metrics, which are the primary concern of many economic agents.

Another aspect of at least some embodiments of the invention is that the amount and type of risk exposures are determined based upon the user's own estimate of the variability of one or more short term rates. This is in contrast to other fixed income optimization solutions, which are driven by the expected total return and/or price volatility of the portfolio, often in a no-arbitrage or risk-neutral setting. Another aspect of at least some embodiments of the invention enables the user to target a specific expected cost and/or cash flow risk metric by determining the size or structure of one, or a combination of, financial instruments. Another aspect of at least some embodiments of the invention allows the user to determine a minimum risk position and from that position assess the tradeoff between lower expected cost and additional expected risk. In this way, analogies can be developed in managing the liability portfolio in a more active fashion, similar to the current active management strategies implemented by investment managers. Further, additional simplification benefits may be gained from the preferred embodiment of at least some embiodiments of the invention at least because only a distribution of short-term interest rates only is required for to generate solutions. This is in contrast to existing fixed income optimization solutions, which require the modeling of entire yield curves, a far more difficult and complex problem. Additionally, the user becomes actively involved in complex concepts related to hedging without necessarily needing to understand fully what hedge ratios are or how they are calculated. In this way, the user becomes far more familiar with many of the counter-intuitive concepts behind risk measurement and management, for example without limitation, with concepts of risk, 1+1 can equal anything between 0 and 2.

Other aspects of at least some embodiments of the present invention include, without limitation, multi-purpose, multi-function analytics developing valuable and often counter-intuitive risk management skills in users, advanced optimization tools within a framework that's relevant for a large class of economic agents, requiring little more than conception of a bell curve or normal distribution. Further, the preferred embodiment of the present invention maximizes use of current personal computer technologies, allows for the use of any type of short rate modeling technique; far simpler than full fixed income yield curve analytics. The preferred embodiment of the invention helps illuminate and quantify otherwise implicit market views, provides a framework for risk taking in liability portfolios facilitating discussions with various constituents including corporate boardrooms, investors, rating agencies, creditors, and governing bodies, and it is well suited for constructing liability benchmarking programs leading to active liability management strategies.

The term cashflow sensitive instrument will be used hereafter. A cashflow sensitive instrument is a derivative or security whose cashpayment(s) will change at least once during its life reflecting at least one element of capital market risk. For instance, a 5 year floating, rate bond whose coupon is tied to the 1M US Treasury Bill yield will have an interest payment of uncertain amount until the instrument matures. Note that assuming no credit risk, this instrument will have a constant or near constant present value through time and thus reflect little if any valuation change. There are many cashflow sensitive instruments however, that will not have a near constant present value. Interest rate swaps, currency swaps, floating rate bonds, adjustable rate mortgages, auction rate securities, indexed notes, and mortgage backed securities are all examples of cashflow sensitive instruments. Note that a fixed rate bond which, absent credit risk, pays a predetermined, invariant coupon rate of interest until maturity is not a cashflow sensitive instrument. A fixed rate bond will, however, change value though time as relevant long term interest rates change. A fixed rate bond is not a cashflow sensitive instrument within this definition.

Means for, steps for, a system for, a computer program product for, and a model or carrying out various combinations of some or all of the foregoing aspects, embodiments, and/or features are also described.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approached, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

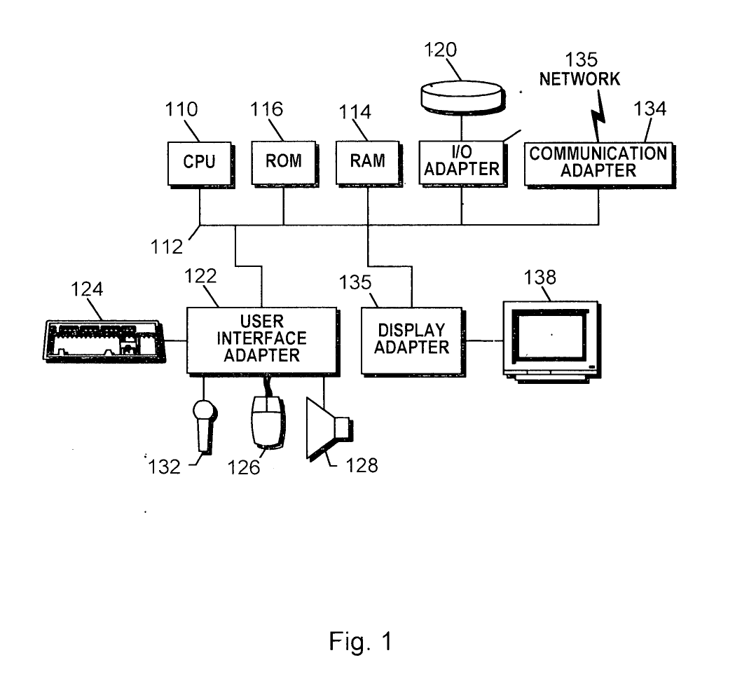

FIG. 1 illustrates a typical computer system that, when appropriately configured or designed, can serve as a computer system in which the invention may be embodied. The compute system 100 includes any number of processors 102 (also referred to as central processing units, or CPUs) that are coupled to storage devices including primary storage 106 (typically a random access memory, or RAM), primary storage 104 (typically a read only memory, or ROM). CPU 102 may be of various types including microcontrollers and microprocessors such as programmable devices (e.g., CPLDs and FPGAs) and unprogrammable devices such as gate array ASICs or general purpose microprocessors. As is well known in the art, primary storage 104 acts to transfer data and instructions uni-directionally to the CPU and primary storage 106 is used typically to transfer data and instructions in a bi-directional manner. Both of these primary storage devices may include any suitable computer-readable media such as those described above. A mass storage device 108 may also be coupled bi-directionally to CPU 102 and provides additional data storage capacity and may include any of the computer-readable media described above. Mass storage device 108 may be used to store programs, data and the like and is typically a secondary storage medium such as a hard disk. It will be appreciated that the information retained within the mass storage device 108, may, in appropriate cases, be incorporated in standard fashion as part of primary storage 106 as virtual memory. A specific mass storage device such as a CD-ROM 114 may also pass data uni-directionally to tile CPU.

CPU 102 may also be coupled to an interface 110 that connects to one or more input/output devices such as Such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 102 optionally may be coupled to an external device such as a database or a computer or telecommunications or internet network using an external connection as shown generally at 112. With such a connection, it is contemplated that the CPU might receive information from the network, or might output information to the network in the course of performing the method steps described in the teachings of the present invention.

In one implementation of the present invention, loaded into memory during operation are several software components, which are both standard in the art and special to the invention. These software components collectively cause the computer system to function according to the methods of this invention. These software components are typically stored on mass storage. An operating system can be, for example without limitation, of the Microsoft Windows™ family. Many high or low level computer languages can be used to program the analytic methods of this invention. Instructions can be interpreted during run-time or compiled. Preferred languages include, but are not limited to, C/C++, and JAVA.RTM. In the preferred embodiment, the methods of the present invention are programed in mathematical software packages, which allow symbolic entry of equations and high-level specification of processing, including algorithms to be used, thereby freeing a user of the need to procedurally program individual equations or algorithms. Such packages include, without limitation, the MATLAB™ computer program manufactured by The Mathworks, Inc. (Natick, Mass.), the Mathematica™ computer program manufactured by Wolfram Research, Inc. (Champaign, Ill.), or the computer program manufactured by S-Plus™ from Mathsoft Engineering & Education, Inc. (Cambridge, Mass.)

It is contemplated that in light of the teachings of the present invention a graphical user interface (GUI) (not shown) may be implemented by those skilled in the art in a multiplicity of suitable forms depending upon the needs of the particular application. For example, without limitation, in some embodiments, it may be Internet based or implemented in a spreadsheet program such as tile Excel™ computer program manufactured by Microsoft Corporation (Seattle, Wash.). In other embodiments, a stand-alone GUI could also be created in accordance with known techniques to effect convenient user input/output. However, depending upon the needs of the particular application, some embodiments of the present invention may not include a GUI; for example, without limitation, some embodiments of the present invention many be configured to directly interact with other software applications through a standard or custom application programmers interface (API).

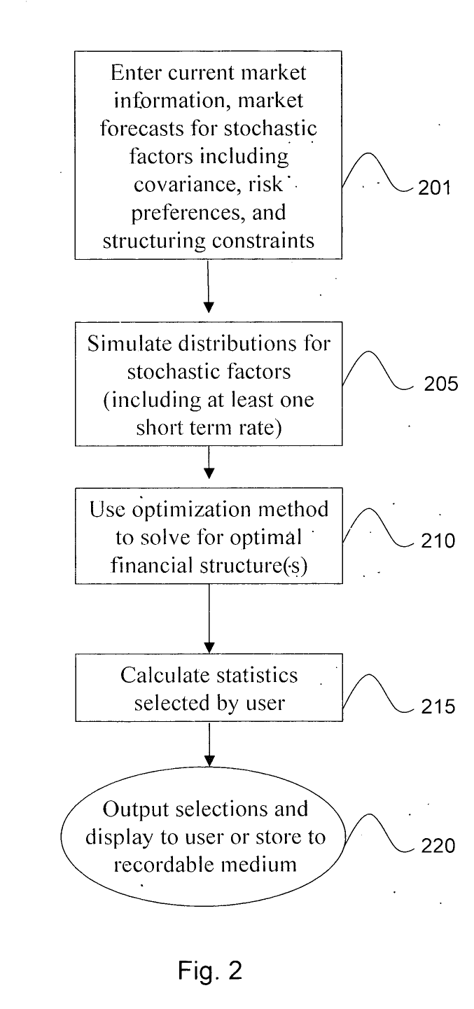

FIG. 2 is a flowchart illustrating exemplary steps for the optimal derivative structure and risk determining method, in accordance with an embodiment of the present invention. In the present embodiment, the method begins at step 201 where the user, using user inputs, generates expectations for and distributions of market variables over a selected horizon that drives cashflow variations in assets and/or liabilities. The user inputs include parameters for at least one short-term interest rate model but may also include other information that falls into categories such as, but not limited to cashflow sensitive instruments, bonds, swaps, investments, rate model specifications, asset model specifications, solution inputs, advanced inputs and output selections. These inputs may include what is referred to as “diffusion inputs” and may also include specifications for the optimization solution such as, without limitation, additional constraints on x or constraints on functions of x. Diffusion inputs are those user defined parameters that develop the construction of the market element distribution(s) or simulation(s) (1M US Treasury Bill yields for example), the mapping of this single or multi-period market element distribution into single or multi-period cash low distributions, and also the optimization parameters to determine the solution. The present embodiment requires the calculation of a distribution of at least one short-term interest rate (usually under 1 year in reset frequency) and preferably one that drives the cashflow cost of liabilities and or returns on certain assets. It may also involve calculating the distributions of factors that drive other asset class returns although this is not required for use of the invention. In the preferred embodiment, this potentially multivariate distribution at least captures the expected covariance structure of the various market elements. In step 205, as described in some detail below, diffusions inputs of step 201 are used to simulate distributions for stochastic factors (including at least one short term rate); for example, without limitation, to generate cash flow distributions and perhaps mark to market changes at selected times by mapping the user's existing or projected financial instruments such as, but not limited to, bonds, derivatives, cash, other assets, etc. This includes the calculation of the short-term interest rate discussed above.

Many different interest rate models are known to those skilled in the art and can be used within the framework of the present invention. Equilibrium models, short-rate models, no-arbitrage models, Heath-Jarrow-Morton frame work models, single factor models, multifactor models, positive-interest models, Markov models, market “fitting” models and market describing models are all examples, without limitation, of types of interest rate models, which, although not explicitly described herein, those skilled in the art, in light of the teachings of the present invention, will readily recognize how to suitably adapt into alternate embodiments of the present invention. It should be appreciated that an interest rate model is generally used to capture the features important and relevant to the needs of the user. The reader is directed to two references for greater understanding of these models, namely, Interest Rate Option Models by Ricardo Rebonato and Monte Carlo Methods in Financial Engineering by Paul Glasserman.

At least four major classes of implementation tools can be used to effect an interest rate model; they are, analytic forms, lattice methods, partial differential equations (grid approaches), and monte-carlo methods. As shown above, interest rate models can be broken into many different taxonomical schema, though the most frequently used models are often simply called by the names of the authors of the academic or white papers that popularized them; for example, without limitation, Black, Derman, Toy (BDT), Brace Gatarek Musiela (BGM), Brennan and Scehwaltz (BS), Generalized Brennan and Scehwaltz (GBS), Cox Ingersoll and Ross (CIR), Heath Jarrow and Morton (HJM), Ho and Lee (HL), Hull and White (HW), Longstaff and Schwartz (LS), and Vasicek are all such name-sake models. In some applications, it is contemplated that users of an embodiment of the present invention may be new to interest rate models and such novice users may find that a powerful yet less complicated model may serve most effectively to create the desired distribution of short term interest rates. A powerful yet simple general model is explored by way of example, and not limitation, below.

Many different methods of simulating more traditional asset returns are also well known to those skilled in the art. Extensions beyond the usual multivariate Gaussian random asset simulation are now commonplace. These might include individually fitting historical univariate return series to custom parameterized distributions using extreme value theory. A multi-variate simulation is then accomplished by next inducing correlations across multiple series through Gaussian or Student t copulas. These methods and others are detailed in the RiskMetric Technical documents and the GARCH Toolbox (Version 2) For Use with MATLAB.

In step 210, as will be described in some detail below, optimization algorithms are executed to solve for risk efficient financial structures. In general, the mantra of modern portfolio management, “Maximize return per unit of risk or minimize risk per unit of return” maps easily into the cash flow framework created here. Because we may be dealing with liability portfolios, “return” may be replaced by “cost” in one of its many forms and as a result we are minimizing instead of maximizing, “Minimize cost per unit of risk and minimize risk per unit of cost.” It will be apparent to those skilled in the art that these minimization objectives will be attained through use of the optimization methods more fully described below.

Examples of applicable methods for unbounded minimization include the Nelder-Mead simplex search method, and the Broaden, Fletcher, Goldfarb, and Shanno (BFGS) quasi-Newton method. For constrained minimization, variations of sequential quadratic programing apply. Examples of applicable solution methods for nonlinear least-squares problems include the Levenberg-Marquardt and Gauss-Newton methods. For handling large data set problems efficiently, one of the many trust-region methods may be employed such as a reflective Newton method for constrained problems. These methods are mole fully described in the Optimization Toolbox for Use with MATLAB Use's Guide Version 3 and associated references.

In one aspect of the preferred embodiment, optimization methods are used to change amounts of exposure or the structures themselves to achieve certain objectives. That is, at least one independent variable exists in the optimization problem, i.e an “x” to be determined. Note that x may be a scalar, vector, or matrix in single or multidimensional spaces. For example without limitation, the size of the exposure, maturity, or amortization schedule, the fixed rate or floating leg on an interest rate or currency swap or fixed or variable spread against same, a basis swap rate or spread, the spread or multiplier rate on the floating leg of a swap, and the strike rate on any type of option such as a cap, floor, “swaption”, currency option, bond option, etc. As mentioned, changing these inputs will result in changes to certain “cost” or objective functions and possibly at least one constraint function.

Actual objective functions might include one of many measures of risk or cost. The following list of risk/cost measures is offered by way of example and not limitation: interest cost, interest earnings, interest cost net of interest earnings (“interest margin”), principal repayment plus interest (“debt service”), debt service net of interest earnings, capital cost, present value of debt service, asset return dollars minus interest expense dollars (defined as “financial margin”), and others. Any one of these might be calculated on the basis of a particular point in time, multiple periods in time, or cumulatively over a long time horizon. If one of these dependent variables is an objective function within the context of this invention, a distribution for said variable must be influenced by changes in one of the independent variables listed by example above. Risk metrics capturing the variability of the statistical distribution may be symmetric or “two sided” calculations such as a simple variance or standard deviation, but for those economic agents concerned about downside risk alone, measures of semi-variance will be more appropriate. These one sided measures often are termed “at Risk”such as “interest at risk” or “debt service at risk” and may be calculated by subtracting the expected value from the confidence level value of the variable in question.

When tail or confidence level calculations are made it may be more meaningful to average all of the tail outcomes as opposed to simply taking, for example, the 95% confidence level statistic. By example and not limitation, at 95% confidence, the risk measure may show zero risk but then the user has received no information about the events that occur less than 5% of the time in the tail. Other entities may be able to withstand a great deal of absolute variability so long as no statistical “worst case” exceeds a certain threshold. In this instance, each of those variables above may be measured at a particular absolute confidence level and the “width” of the variables distribution is not of concern. All of these concepts are reflected in more detail in the RiskMetrics Technical document among other places and will be well known to those skilled in the art.

Additional and important optimization problems result if pricing functionality is incorporated into step 210. As previously discussed, there are differences between market implied views held by those with a mark to market or trading perspective, and those entities with a buy and hold, long term cashflow driven perspective of risk. This may manifest itself quantitatively in different parameters for future short term rates within the interest rate models or other markets element models. For example, without limitation, implied cap volatility as traditionally defined and calculated by capital market participants will typically differ from historical volatility calculations for short term rates. This will lead to a relative value comparison between the actual market value of an instrument or group of instruments and their respective values from the long-term cashflow risk framework. By way of example, and not limitation, one resulting optimization problem includes maximizing the expected present value cashflow difference between the market implied model and the model calibrated to a long-term historical view. This optimization, in this case, would be accomplished by determining weights between different structures that maximize this present value cashflow differential.

Multiple constraints may be incorporated into step 210. For instance, an objective might be to lower expected dollar cost but without increasing the size of a particular structure by more than 150%. That is, there may be upper and lower bounds on the independent variable x itself. Any of the independent variables listed above may have bounds that serve as additional constraints. Further if for example, the goal is to minimize a certain risk measure such as dollar volatility, an additional constraint may preclude the expected annual average dollar cost from going above a certain level. Similarly, if the objective is to minimize a certain expected dollar cost, a constraint might be to preclude solutions where the 95% highest dollar cost exceeds a particular threshold. In addition to upper and lower bounds on the independent x variables themselves, all of the objective variables and associated statistical metrics above may be incorporated within optimization constraints as well.

If applicable and during optimization execution, as structure parameters change within one or more financial instruments, it is preferable in many applications to have the prices of these financial instruments change as well. It should be appreciated that pricing algorithms well known to those killed in the art may be incorporated within the optimization. This may affect the output of objective functions and constraint functions which obviously influence the final result. Depending upon the problem type and needs of the particular application, this feature may be less important than computational speed. In step 215 statistics to calculate are selected by the user and are thereafter calculated. Finally in step 220 the results of the calculations are displayed to the user and/or stored to a recordable medium. The system may output generic output or display scenario/optimization specific outputs. Further, steps 205 and 210 can be combined as long as the stochastic factors ale calculated prior to the implementation of the optimization algorithm. Without at least one stochastic factor distribution, it is impossible in the current invention to evaluate the objective function in a non-trivial way.

The below description of an embodiment is relevant to the public finance industry where local governments and certain corporations with not-for-profit status issue bonds whose interest is exempt from Federal income tax. This was chosen due to the very long planning horizons common in public finance as well as the importance of managing interest rate risk in this sector. In the tax-exempt market, short-term interest rates are represented by the Bond Market Association Municipal Swap Index (“BMA”). In the taxable money markets, the benchmark index is the London Interbank Offered Rate (“LIBOR”). These two indices and their relationship drive the vast majority of the cash flow volatility inherent in issuers' debt portfolios. For many state and local governmental issuers it will suffice to employ a two factor model to explain three different relevant short term rates: the BMA index, LIBOR and the BMA/LIBOR ratio.

As mentioned above, in step 210 the distribution of at least one short-term interest rate is calculated.

By way of example and not limitation, one simple analytic way in which to create a distribution of rates at points in time is to select a mean or average rate at each time point, Rₜ, and then use a simple exponential function to create a full distribution at that time point. This will create a Black style volatility result at each time step. Assume for example that the expectation for the short term rate in question in 6 months is 5% and volatility, vol, is 25%. By creating discrete increments, zᵢ, from −5 to 0.5 in. 0.1 steps we can use the following formula to generate 101 rates from 2:2676% to 9.341%:
ᵢrₜ=Rₜexp(vol*zᵢ*dt)
where ᵢrₜ, is the ith simulated rate at time t and dt is time in years from the simulation start date, in this case equal to 0.5. Thus we have created a 101 step distribution from −5 to 5 standard deviations from the expected rate of 50%.

As a further example, a generalized mean reverting stochastic differential equation (SDE) that lends itself to creating distributions of short-term interest rates is:
drₜ=αₜ(mₜ−rₜ)dt+rₜ^{α}σₜdZₜ
where rₜ, is the short term interest rate at a time t, drₜ is the instantaneous change in a short term interest rate such as, but not limited to, Federal Funds Rate, Prime, LIBOR, 1M Treasury Bill yields, or BMA (a “short rate”), mₜ is the average rate to which simulated rates in the model revert, not to be confused with M the market set described in more detail below, αₜ is the reversion speed at time t and α is a scaling parameter which controls how much the volatility of the model is dependent upon rates. With α=1 the model displays lognormal volatility which is a market convention for vanilla caps and swap options, sometimes referred to as “swaptions”. The volatility parameter, σₜ, can be a scalar constant, a deterministic function of t, or even driven by another stochastic function. dZₜ is assumed to be the increment of a standard Brownian motion.

For purposes of creating distributions of t rates at particular points in time in the present embodiment, the SDE is preferably discredited in order to decrease the computational burden of many time steps, particularly over long horizons. An exemplary discrete version of the model above is:
Δrₜ=αₜ(mₜ−rₜ₋₁)Δt+rₜ₋₁^{α}σₜ\sqrt{Δt}·zᵢ
It is assumed that zᵢ is an independent Gaussian random variable with 0 mean and unit variance (zᵢ˜N(0, 1)). The us giving a straightforward way to simulate short term rates:
rₜ₊₁=rₜ+αₜ(mₜ−rₜ₋₁)Δt+rₜ^{α}σₜ\sqrt{Δt}·zᵢ

This approximation method is called the forward Euler method and converges to the continuous solution as Δt approaches 0. Accuracy can be improved by adding a correction term through the Milstein Scheme (see reference above). The foregoing type of model equation is helpful for analyzing path dependent structures where the cumulative cashflows over a period are relevant for the use. Cumulative cash flows or statistics may be part of the objective function and therefore path dependency in the simulation would be desirable. It is contemplated that applications where cumulative totals or results are the goal can be effectively analyzed with the foregoing model, or embodiments thereof.

Given the market's tendency to display wide swings more frequently than the normal distribution might suggest, other extensions might include having zᵢ distributed as a Student T or multi-normal distribution.

In applications where asset returns are also modeled; as would be most likely encountered among not-for-profit healthcare or higher education institutions, these instruments can be modeled and adapted into a multiplicity of alternate embodiments. Preferred embodiments of the present invention implement the covariance structure of the assets with the short rates modeled above.

An example of this type of model would be, without limitation:
dSₜ=a(Sₜ,t)dt+b(Sₜ,t)dZₜ
where Sₜ is the asset, a( ) is a drift function through time, and b( ) is a volatility term. A straightforward embodiment could be implemented with a constant drift term, μ, and constant volatility term, σ:
dSₜ=μSₜt+σSₜdZₜ

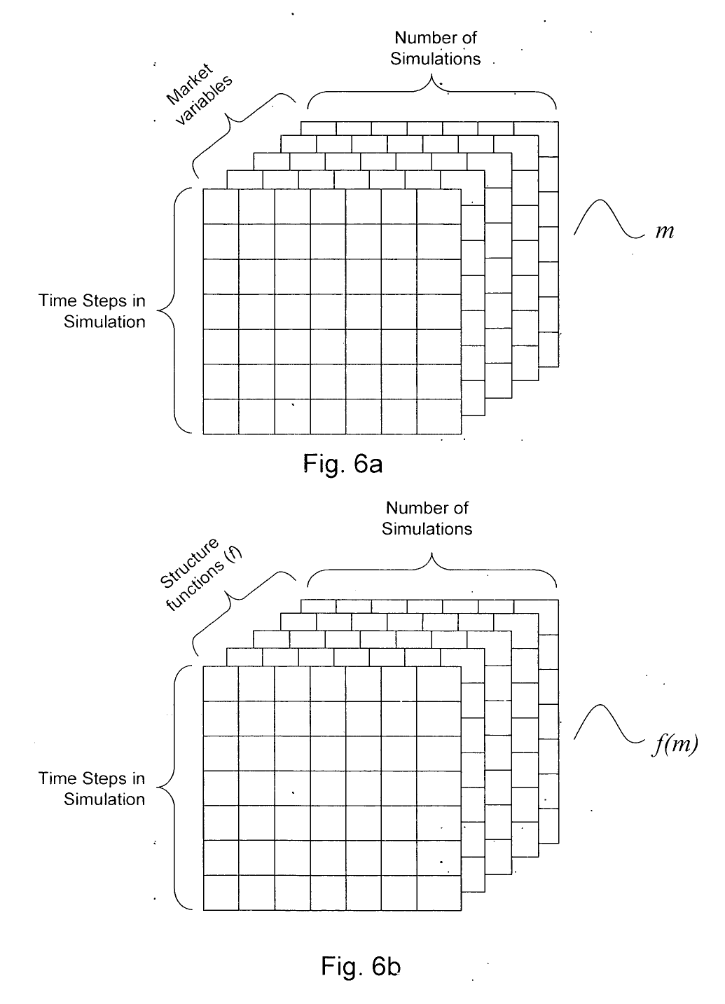

In the present embodiment, once the desired distributions have been created, the user must then map the distribution of market factors into distributions of cashflows. One way this can be conceptualized is through the use of matrices. A 3 dimensional array of market variables, M, can be generated. One Such array is shown graphically in FIG. 6, which is described in some detail below.

The next few sections describe step 210 of the present embodiment, the construction of the problem and the optimization formulations that result.

Debt service is the generic term in public fiance for principal and interest payments that result from issued bonds and other debt. The debt service payments made during each usually annual budge period can be described in a straightforward way, though abstract for many participants in corporate finance: This abstraction points to an optimization problem however which sheds new light on the challenges faced by cash flow sensitive entities managing their capital market exposures. During each (budget) time period, represented as t cash flows from the issuer can be described as:

$${C}_{t} = {P}_{t} + {\sum }_{i = t + 1}^{m} {P}_{i} {c}_{i} + {\sum }_{j = 1}^{n} {N}_{j} {f}_{j} ( {M}_{t} )$$

where Cₜ is cashflow during budget time t, though t could be a single point in time as well, Pₜ is principal paid at or during time t, P is principal paid at times later than t, c are coupon rates paid on fixed or floating rate bonds prevailing at or during time t, and N and f are notional amounts and functions of market variables respectively. Cash flow from the issuer during a time t is equal to the principal paid by the issuer during time t, plus interest on bonds during time t, plus net payments on derivatives and other financial contracts (i.e. cash or other investments). For simplification, P and N within the two right hand terms are assumed to be scaled by the applicable payment frequency of the bonds or derivatives (monthly, semi-annual, etc) and day Count convention for example, without limitation, Actual/Actual, Actual/360, 30/360, etc.

In some embodiments of the present invention, a more traditional mark to market calculation for securities may also be added to the term above. This term, if used, is one to which a great deal of analytic attention and focus has been paid, given that many financial entities performance is driven by the daily change in periodic marked-to-market value. Adding such a term would obviously have important implications for the distribution of Cₜ and ways in which it can be manipulated. However, the reality is that many corporations and even individuals who manage financial risk do not view a change in market valuation of instruments (owned or sold) is a true “cash event.” As such, for those entities it would be inappropriate for that term to be included here.

In matrix notation the above construction of the present embodiment is as follows:
Cₜ=Pₜ+P^{T}c+N^{T}ƒ(Mₜ)
N in this situation is a column vector of notional amounts and ƒ(Mₜ) is a column vector of rate payoff functions for derivatives. P is a column vector of the principal amounts of bonds paid after time t and c is a column vector of respective coupon rates for those principle amounts.

In the list below, the abbreviation SR is used for “short rate”. Relevant examples of ƒ reflecting the term is of Cashflow Sensitive instruments include, without limitation:

| | |
|---|---|
| Floating rate bonds | fᵢ(M) = SR |
| Money market fund/cash | fᵢ(M) = −SR |
| Interest rate swap | fᵢ(M) = SwapRate − SR |
| Currency swap | fᵢ(M) = SR1 − SR2 |
| Cap | fᵢ(M) = max(0, SR − Strike) |
| Floor | fᵢ(M) = min(0, SR − Strike) |

Examples of ƒ that might be specifically relevant in the public finance arena include, without limitation:

| | |
|---|---|
| Tax-exempt Floaters | fᵢ(M) = BMA (+support costs) |
| BMA Swap | fᵢ(M) = SwapRate − BMA |
| LIBOR Swap | fᵢ(M) = SwapRate − LIBOR (or % LIBOR) |
| Basis Swap | fᵢ(M) = % LIB − BMA |
| BMA cap | fᵢ(M) = max(0, BMA − Strike) |
| BMA floor | fᵢ(M) = min(0, BMA − Strike) |
| Cash earnings | fᵢ(M) = LIBOR |

In the examples immediately above, ƒ is a function of market variables BMA and LIBOR, though these are simply representative. The fixed income derivative markets have developed a wide variety of priceable functions of market variables and continue to innovate daily. Further, there are no theoretical limits to the size and range of market variables in M. Of course practical computational limitations apply. BMA and LIBOR are chosen to illustrate the points because, as previously mentioned, the vast majority of cash flow or operating, performance risks in public finance are driven by changes in these two rates. By way of example and not limitation, other short term rates that may drive cash flow earnings, interest expense, or net income in other industries or countries include PRIME rates. Federal Funds rates, Commercial Paper rates, US Treasury bill yields, Certificate of Deposit rates, inflation rates, EURIBOR, banker's acceptance rates, and exchange rates.

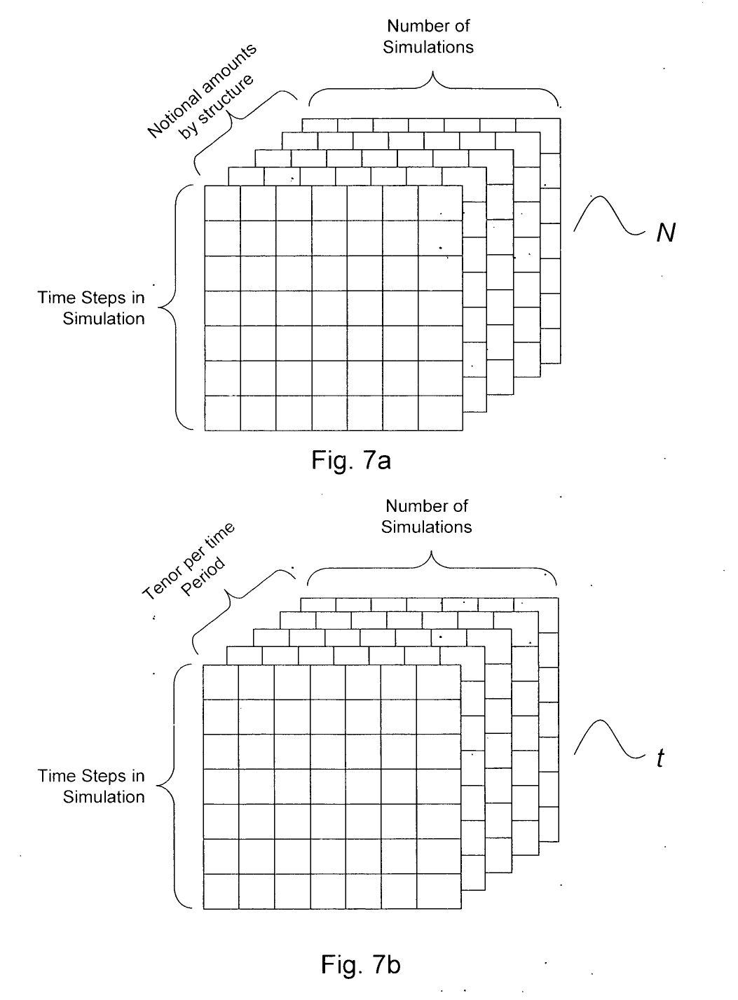

Continuing with the example of the present embodiment, with M calculated, the cash flows and/or mark to market changes from actual liability, asset, or derivative structures as reflected by ƒ(M) can now be evaluated, see FIG. 6b. In order to derive cashflow projections for interest rate derivatives, ƒ(M) is usually scaled by the both the tenor of each cashflow and the amount of the exposure as reflected by the principal or notional amount, t and P. These three-dimensional arrays are represented below in FIG. 7. As described in some detail below, in the preferred embodiment of the present invention, these cashflow projections are calculated based on the distribution of interest rates (i.e., a cashflow risk) and parameters related to the selected financial instrument to be evaluated.

Now that Cₜ is defined, it can be seen that, since M reflects market variables that have some random nature (i.e. they are “stochastic”), the sum of functions of M that generate Cₜ itself result in a stochastic variable which has an expectation, E[Cₜ], and a variance, Var[Cₜ]. One simple goal for Cₜ might be to minimize both expectation and variance. However, this may go too far down the path of defining risk for an entity. Absolute variation may not be a concern as previously discussed. Rather, a tolerance may exist for great cashflow volatility as long as capital cost doesn't exceed a fixed percent, for example, without limitation, 6%. Or perhaps, an entity doesn't want to exceed 6% with 95% confidence. Since C₁ is a random variable, if modeled properly a full distribution of Cₜ should be available for each relevant point in time or in aggregate for complete multi-period budgeting.

A number of pertinent considerations result from this formulation relating to how one call manipulate the distribution of Cₜ. In the present embodiment, there are basically four discretionary items: the amount of principal due in the period, Pₜ the notional amount of bonds or derivatives in the period, N, the types of derivative or bond functions, ƒ, or the amount of principal due after t, P. These are the degrees of freedom in the problem. This formulation leads to many questions the answers for which current industry standard software provides little if any insight, for example, without limitation, the following questions: What amount of BMA variable rate exposure in a period generates the minimum volatility for Cₜ? How much BMA/LIBOR basis swap risk would offset existing BMA variable rate exposure? What combination of BMA variable rate and BMA/LIBOR basis exposures leads to the minimum expected cost? What amount of cash (earning LIBOR) would provide the best expected hedge to an existing debt and derivative portfolio? How should the hedge strategy change given a change in expectation about rates? What impact on a debt portfolio would result from a change in the expected correlation between BMA and LIBOR? What adjustments would be made in order to minimize risk in the event this change occurs? If broader asset class returns are included, what combination of assets creates higher expected net financial spread and/or lower expected financial spread volatility where the fanatical spread are the modeled asset returns less the cashflow cost of the debt?

In this way, the foregoing has addressed a method of creating distributions of market variables, including at least one short-term interest rate, and its interrelation to some embodiments of the present invention and the mapping of these distributions to cash flow distributions, Cₜ.

In the present embodiment in step 215, these calculations are extended by using, single and multi-objective optimization algorithms to actually solve for types or amounts of risk exposures that minimize cumulative or periodic Cₜ. Var[Cₜ], or other statistics, examples of which have already been described. These selected calculations are then displayed to the user through the user interface or stored to a recordable medium in step 220.

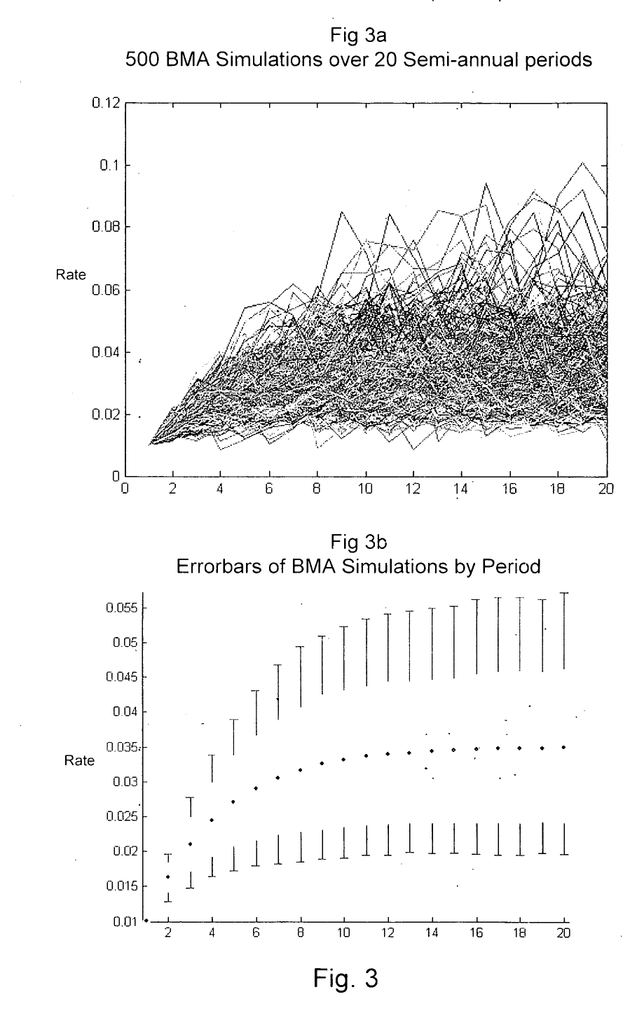

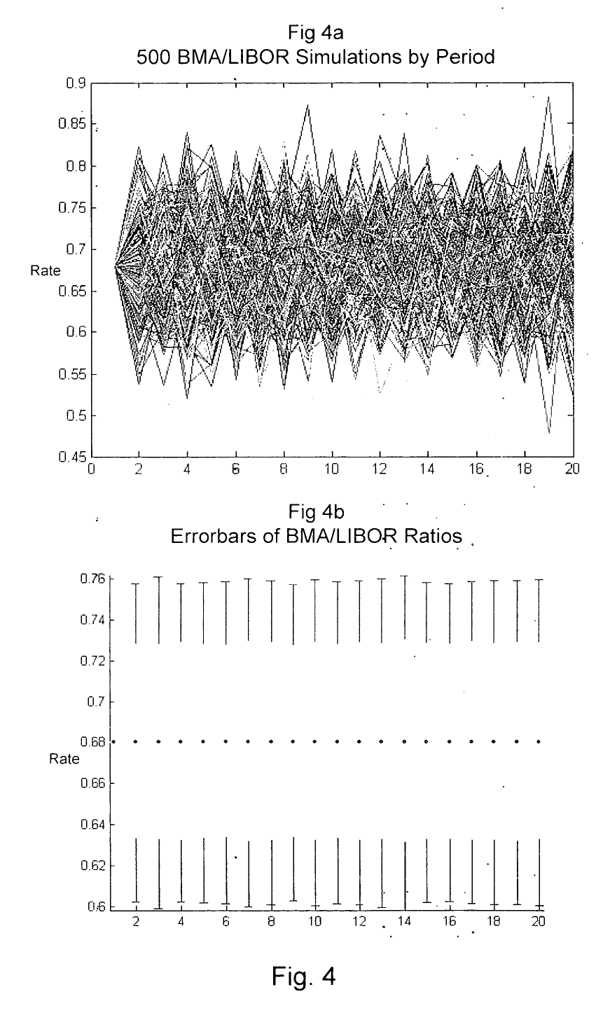

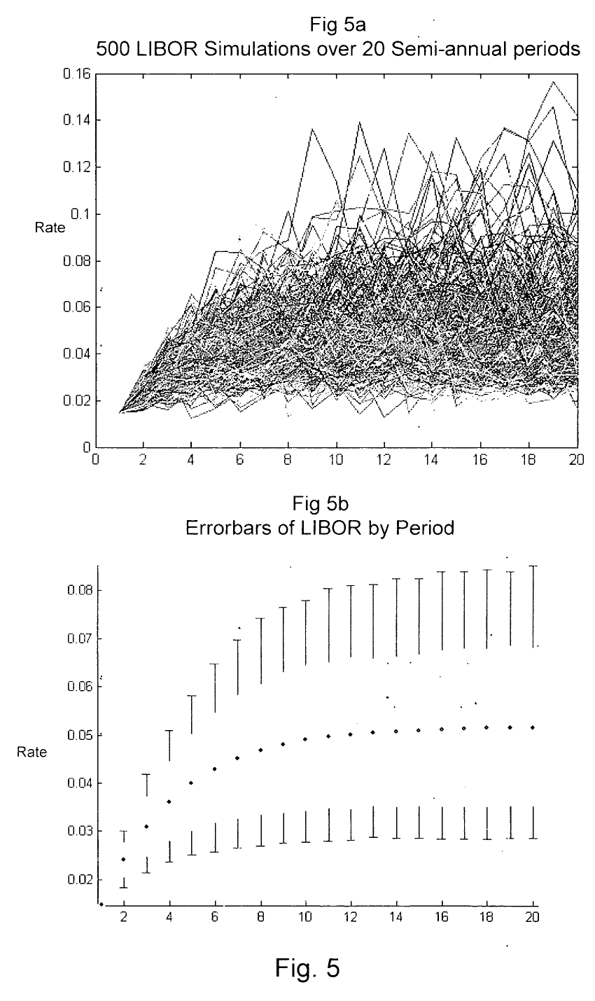

FIGS. 3 though 5 illustrate exemplary simulations of different rates in graph form and as average rates, in accordance with an embodiment of the present invention. FIG. 3 shows BMA simulated semi-annually over 20 years. FIG. 4 shows all average of the BMA/LIBOR ratio modeled over the same time frame. The BMA rates in FIG. 3 divided by the BMA/LIBOR ratios in FIG. 4 yield the simulation for LIBOR itself shown in FIG. 5. The graphs illustrated in FIG. 3a, FIG. 4a, and FIG. 5a show the graphs of 100 trial simulations of the rates. FIG. 3b, FIG. 4b, and FIG. 5b show the same information with the average rate at each point in the simulation shown as a black dot, and red and blue error bars showing one to two standard deviations from the mean in the upper and lower direction respectively.

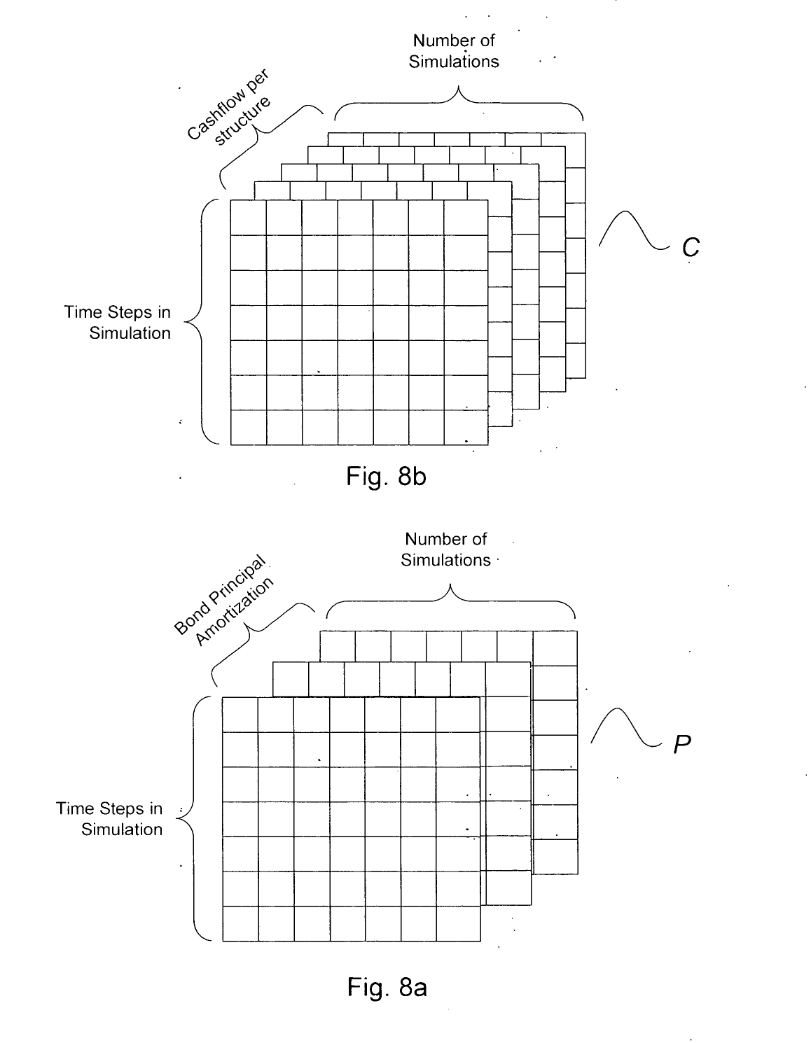

FIGS. 6 through 8 illustrate three-dimensional matrixes for a number of different exemplary simulations, in accordance with an embodiment of the present invention. FIG. 6a shows a representation of a 3 dimensional matrix of (rows X columns X panels) time steps X number of simulations X number of market variables, called “M”. FIG. 6b shows a 3 dimensional matrix of time steps X number of simulations X functions of market elements representing financial instruments such as derivatives, investments, or assets, called “ƒ” or “ƒ(M)” throughout this disclosure. FIG. 7a shows a representation of a 3 dimensional matrix of time steps X number of simulations X notional amounts of bonds or derivatives, called “N” throughout this disclosure. FIG. 7b shows a 3 dimensional matrix of time steps X number of simulations X time increments in years, called “l” throughout this disclosure. FIG. 8a shows a representation of a 3 dimensional matrix of time steps X number of, simulations X cashflows for each structure, called “C” or “Cₜ” throughout this disclosure. FIG. 8b shows a 3cl dimensional matrix of time steps X number of simulations X principal payments on bonds in number of market elements, called “P” throughout this disclosure. In the present embodiment, each matrix or “panel” represents a different market element within M. On each panel, rows represent each time step in the simulation going from nearest to farthest away in time, while tile columns are the number of simulations going from left to right, l to n. The top row of each matrix is the initial rate or price for that market variable within the simulation. In order to decrease the computational complexity of the problem and for illustrations sake, each of the arrays shown FIG. 6-8 are intended to have the same number of elements along each row and column (time steps and simulation paths) in order to facilitate linear algebraic computation and speed. It should be noted however that in a fully general implementation this computational convenience is not required. Each instrument may have different payment dates, payment frequencies, reset dates, indices, and day-count bases. For larger portfolios of instruments, however, current computer technology would likely be taxed by such calculations and particularly the resulting optimization.

With these simulations in place, in many applications, a sufficient approximation, if not true variability in debt service expense and financial performance is captured, offering the ability to create “optimal” structures. Possible objective functions for an optimization include without limitation: expected periodic or total average capital cost, expected periodic or total total/present value interest expense, expected periodic or aggregate cashflow standard deviation, and 95% (or other) confidence Cashflow At Risk (95% highest minus mean).

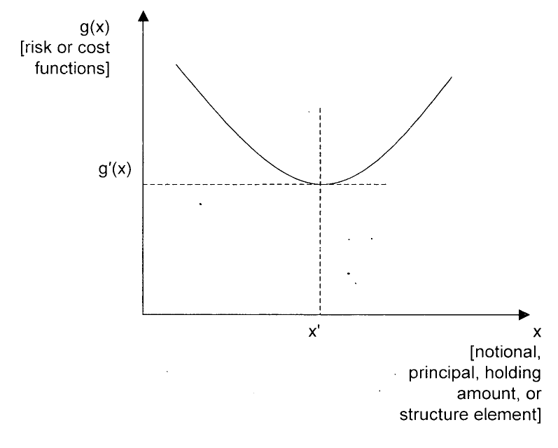

FIG. 9 illustrates graphically the minimization of an exemplary function, g(x), by changing an input scalar or vector, x, to find the minimum, g′(x) at x′, in accordance with an embodiment of the present invention. For many applications, a general nonlinear optimization problem can be, without limitation, mathematically constructed according to the following exemplary approach, in accordance with an embodiment of the present invention:

$${min}_{x} g ( x )$$

$$subject to$$

$$c ( x ) \leq 0$$

$$ceq ( x ) = 0$$

$$A \cdot x \leq b$$

$$Aeq \cdot x = beq$$

$$l b \leq x \leq ub$$

where x, h, beq, lb, and ub are vectors, A and Aeq are matrices, c(x) and ceq(x) are functions returning vectors, and g(x) is a function returning a scalar (reference Matlab Optimization user's manual). Applied to the problem formulated above, g(x) is some function of Cₜ such as E[Cₜ], Var[Cₜ], or Cₜ at some confidence level. The x might be an input such as, but not limited to, the principal amount of certain bonds, P, the notional amount of swaps and derivatives, N, or the structure of certain functions,ƒ. Depending upon the selection of the x or independent variable, many different constraints may apply.

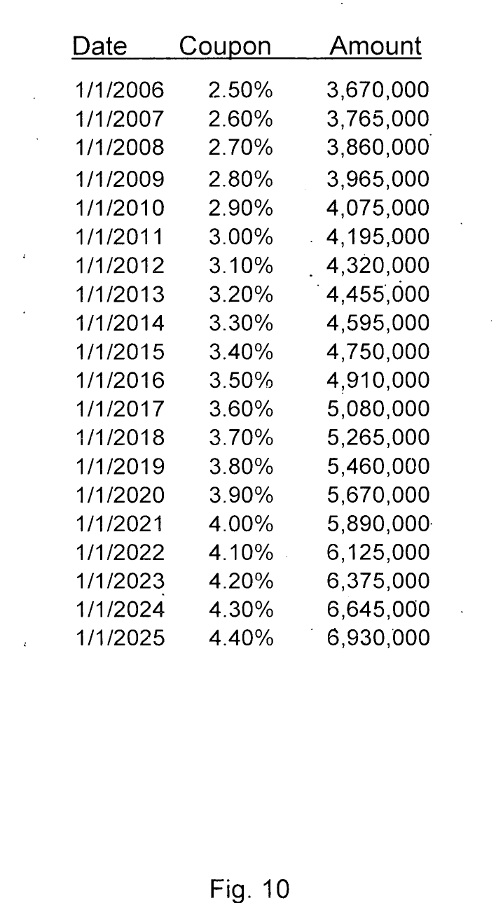

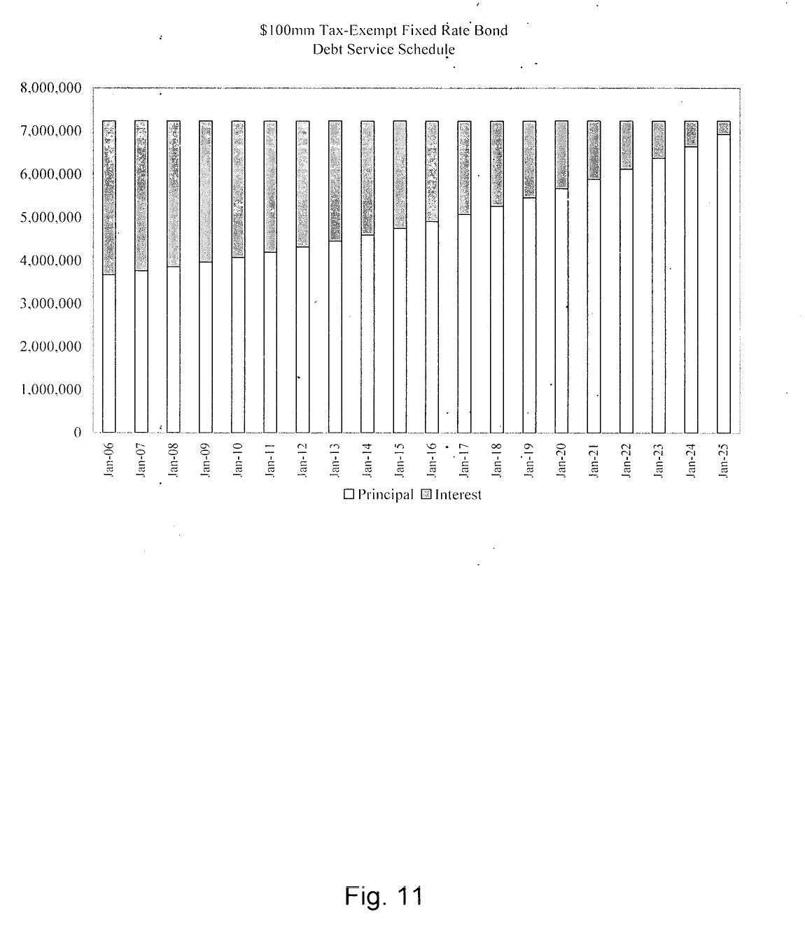

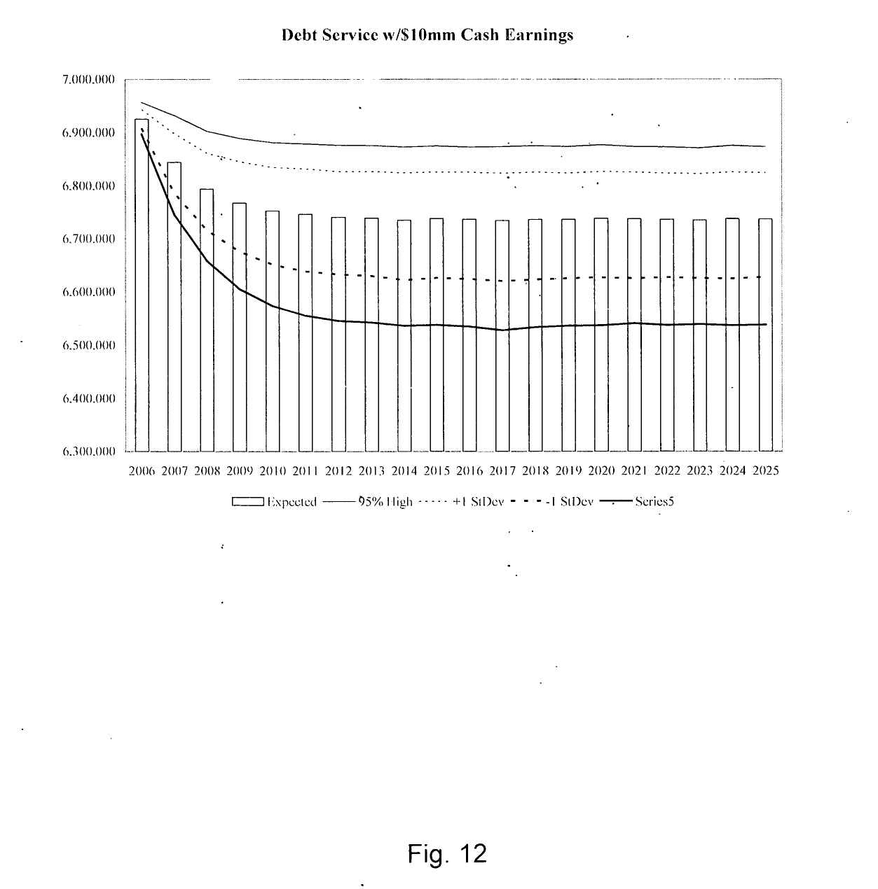

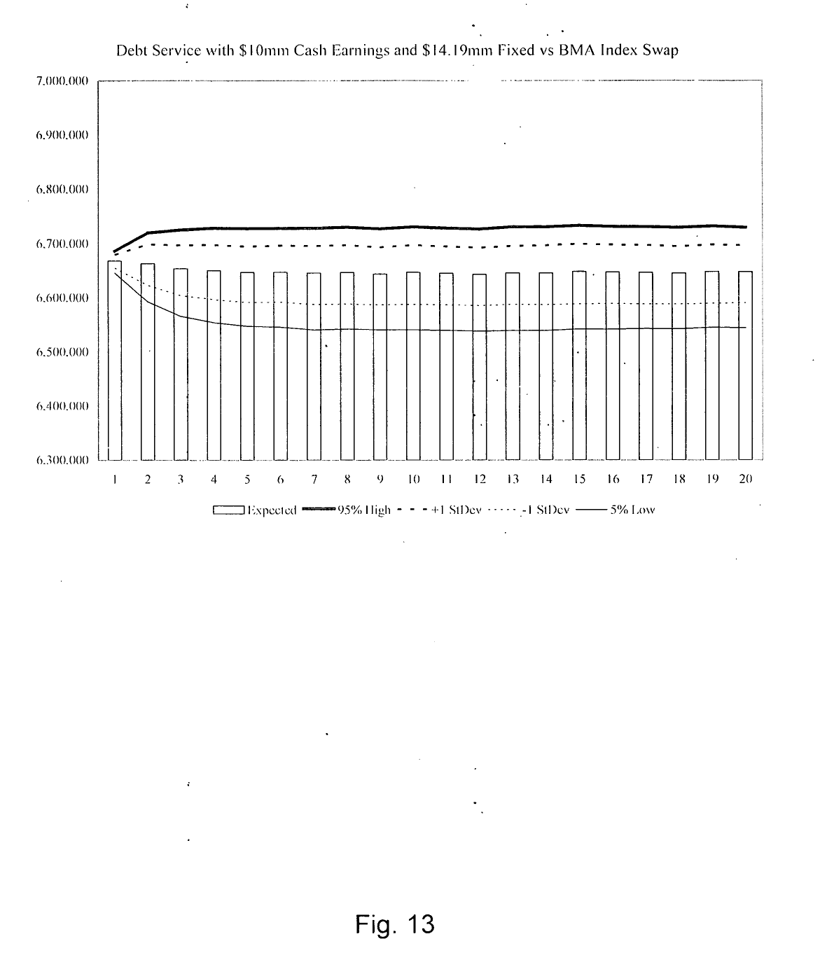

FIGS. 10 through 13 illustrate exemplary information for the following example calculations, in accordance with an embodiment of the present invention. FIG. 10 shows an exemplary table of Coupon rates and principal amounts for hypothetical bonds issued on Jan. 1, 2005. FIG. 11 shows the annual principal and interest payments required to pay off $100 million in bonds at the coupon rates shown in FIG. 10. FIG. 12 shows the annual principal and interest payments from FIG. 11 net of the earnings from $10 million in cash, assumed to earn LIBOR, a short term modeled rate. FIG. 13 shows the annual principal and interest payments from FIG. 12 after adding a BMA based swap to floating in the amount of $14.19 million. A few practical examples will next be set forth to better convey some implementation specific aspects of the present invention. All examples are not intended to be comprehensive or limit the invention in any way, but instead set forth some suitable uses and/or configurations for certain applications. Those skilled in the art of the present invention, in light of these examples and the foregoing description, will readily recognize a multiplicity of alternate, and suitable, implementations and configurations of the present invention depending upon the specific needs of the particular application.

### EXAMPLE 1

$100 mm Debt, 20Y Level. $10 mm Cash

In the present example, it is assumed that an issuer has $100 mm of debt outstanding at maturity amounts and coupons as shown in FIG. 10. Retiring these bonds in full requires that the municipality meet total principal and interest on an annual basis of approximately $7.1 mm as reflected in FIG. 11. Further, the issuer is deciding to enter into an interest rate swap where the issuer receives a fixed rate of interest and pays a floating amount of interest based upon changes in the BMA index (often called a “swap to floating” or “fixed receiver swap”). How large should the interest rate swap be?

Traditionally, this type of decision has been driven by a combination of subjective factors including, but not limited to, rating agency views, risk appetite, revenue stability, debt service coverage, and other metrics of financial flexibility. For instance, without limitation, rating agencies often viewed floating rate exposure greater than 20% of total debt outstanding as unusual and requiring specific explanation. Many in the public finance industry still view 20 to 25% of total debt as an unspoken high water mark for floating rate risk. More recently, the concept of using cash balances as a natural, rate sensitive hedge for tax exempt floating rate exposure has developed and become commonplace. In addition, the amount of a swap outstanding at any given time is usually restricted to the amount of bonds outstanding. Anything, more would likely be considered speculative and such activity is often prohibited by an issuer's own debt policy or even state and/or local laws.

If it is also assumed that this issuer has $10 million in cash assets earning returns correlated with LIBOR over the 20 year life of the transaction, then a graph showing principle and interest on the debt net of earnings on the cash can be created as shown in FIG. 12. In FIG. 12 it is now clear that the periodic debt service is actually a random variable with a complete distribution in each budget year. A natural question from this construction is, “What size swap would minimize the net variability in overall cashflow?” The answer is dependent upon how the interest rates have been modeled which was originally driven by the expectations of the issuer.

In the present example, rates were simulated using the lognormal version of the mean-reverting model described in detail above for both BMA and the basis relationship between BMA/LIBOR. The LIBOR simulation was created by dividing the BMA simulated rates by the rates in the basis simulation as mole fully described above. The parameters for both the rate and basis simulations are shown below:

BMA model

| | |
|---|---|
| Number of simulations = | 10,000 |
| Years of simulation = | 20 |
| Settings annually = | 2 |
| Reversion Speed = | 0.50 |
| Initial rate = | 2.00% |
| Average rate = | 3.50% |
| Rate Volatility = | 25.0% |

BMA/LIBOR basic model

| | |
|---|---|
| Number of simulations = | 10,000 |
| Years of simulation = | 20 |
| Settings annually = | 2 |
| Reversion Speed = | 0.50 |
| Initial rate = | 72.00% |
| Average rate = | 68.00% |
| Basis Volatility = | 10.0% |
| Correlation BMA/basis = | 0.0% |

$${min}_{c} avg ( stdev ( {C}_{t} ) )$$

Using these parameters in the short-term rate simulations and using the average annual cash flow volatility as the objective function to be minimized, results in a BMA swap to floating of approximately $14.19 million. This swap reduces the average annual cash flow volatility of the debt structure with $10 million of cash from approximately $91,000 to approximately $50,000. By way of example, and not limitation, other kinds of financial instrument parameters that might be used in other applications include the interest or currency rate on a swap, the strike rate on a cap, floor, or other option, the multiplier or arithmetic spread applied to a floating rate index on a swap or debt instrument, the exposure amount to any of the above instruments.

This solution was generated by finding a single scalar value which, when applied to the entire input notional schedule, minimizes average annual cash flow volatility. The optimization call also be calculated on a period by period basis giving a unique notional amount for each time step in the simulation or budget period.

If x is the initial “guess” for the notional schedule on the interest rate swap, the problem is to find a scalar c such that c x minimizes average annual cashflow volatility, or mathematically:

Note that the answer above assumes zero correlation between BMA and the basis relationship of BMA to LIBOR. If the input is changed from 0% correlation to 10% correlation between BMA and the BMA/LIBOR basis model, the optimum swap size that minimizes cashflow volatility falls to $13.6 million.

Note the similarity between this example and a homeowner who is borrowing a million dollars for a home and is deciding whether to employ an adjustable rate second mortgage given they hold $100,000 in money market type investments. It is essentially the same financial problem and the answer will be influenced in an unintuitive way by the expected correlation between the adjustable mortgage rate and the return on the money market holdings.

Further, contrast this process with that of a fixed income portfolio manager owning the same fixed rate bonds and looking to use an interest rate swap to hedge the mark to market changes of all or a subset of said bonds. The manager is far more concerned with the duration of the swap vs. the bonds, the correlation between swap market pricing and bond market pricing, and the holding period of the hedge than the public finance manager above. The cashflow sensitive financial manager thinks about the problem very differently; some would even say teat the process the public finance manager follows is “irrational.” It is actually a very rational understanding of the types of risk to which the Board/elected officials are highly sensitive. Therefore, the invention reflects a quantitative analysis designed within the end user's and decision maker's framework.

### EXAMPLE 2

Cap Rate

In the present example, a for-profit corporation has issued $100 million of floating rate bonds indexed to LIBOR at the rates generated above in Example 1. Management has decided that over the next 5 years it can comfortably manage $300,000 of semi-annual interest expense volatility. If management were to put in place a $100 million interest rate cap over the next five years, at what rate should the cap be set so that the annual interest expense volatility falls from its current $506,000 to the target goal of $300,000?

With the LIBOR simulation identical to the one described in Example 1, an optimization problem arises in that we are seeking the maximum rate the strike rate on the cap can be such that the target cash flow volatility of $300,000 is attained. It is found that with a cap rate of 3.85%, semi-annual interest expense volatility falls to $299,605.

Another question might be to determine how much (in notional) of a 3.50% cap would be required to achieve the same $300,000 risk target. Given the simulation parameters above, the answer is $48,250,000.

### EXAMPLE 3

Not-for-Profit Hospital System Evaluating How Much Cash to Hold

The issuer in this example is a not-for-profit hospital system managing $2 billion in tax-exempt debt with an average life of 15 years, and $3 billion in investment assets spread across money market funds, domestic investment grade and sub-investment grade fixed income investments, foreign and domestic equity holdings, and some market neutral hedge funds. The debt is issued in roughly equal fixed and floating rate modes, and 50% of the floating rate bonds are hedged with LIBOR based interest rate swaps ($500 million notional in swaps) where the hospital pays fixed and receives floating.

By creating a multivariate distribution of short term BMA and LIBOR rates and the various asset classes above, statistics of “financial margin” or “financial spread” can be calculated by taking the return on the asset portfolio and subtracting the cost of the debt portfolio (with or without principal repayments) at each of the simulated points in multi-dimensional space. This financial spread, as with any of the other cost and return statistics, is a stochastic variable with an expectation that can be maximized through many different permutations of the underlying inputs including notional amounts of derivatives (N above), the structure of the derivatives (ƒ), the various asset holdings including cash, or the principal amount paid in the period Pₜ. Therefore, we have another optimization problem where the objective may be to maximize financial margin (minimize the negative of financial margin) by changing any one of the various independent variables mentioned above.

### EXAMPLE 4

Rate Adjusted Principal Amortization

As described above, variable rate bonds or adjustable rate loams are considered risky due to the budgetary uncertainty they introduce into aggregate payments of principal and interest. One method by which to manage this risk and partially stabilize total debt service is by retiring more bond principal when interest rates, by some metric, are considered low, and alternatively retiring less principal when interest rates are determined to be high. A challenge with this strategy occurs if interest rates go up and stay up, at which time the borrower/issuer is behind schedule relative to the expected principal and has to “catch up” on retirement of principal. In this case, it's possible that higher than expected principal payments would need to occur high interest rate environments leading to very high debt service payments.

The present example assumes a borrower has a 20 year variable rate loan with a specific annual principal repayment schedule based upon an assumed 6% annual borrowing rate. The annual expected debt service payment for this loan is approximately $8.7 million. If this loan had been originated in 1985 as an adjustable rate loan indexed to LIBOR, debt service volatility would have been $1.36 million. If a simple formula is used to adjust the original principal schedule by an amount reflecting the then current interest rate environment, the result is a relatively more stable debt service schedule. It should be noted that if this formula had been used to adjust the principal retirement schedule of the LIBOR based loan originating in 1985, the debt service volatility is reduced by 48.6% to $698,000 from the original $1.36 million. Moreover, the maximum year over year difference in debt service between one year and the next is $2.69 million in the original case, but only $1.1 million in the adjusted scenario, a reduction of over 59%.

### EXAMPLE 5

Hedging Currency Exposure

The present example assumes that a company based in the USA sells some of its products in Europe, and thereby, the company is exposed to the risk of dollar strength or Euro weakness as some of its revenues are based in Euors. Given the other cash flow exposures the company has to interest rates and currencies, embodiments of the present invention may be used to answer, among other aspects, what size $/Euro currency swap would minimize expected cash flow volatility for the company. For instance, the size may be determined by using, information as described in step 201 of FIG. 2 to simulate factors that effect cash flow volatility. In this case, assuming LIBOR is an interest rate index to which the company has exposure, the company would use a forecast for expected levels for and the covariance between LIBOR and $/Euro exchange rates to generate correlated distributions of LIBOR and $/Euro over the chosen analytic horizon. Based upon this market element simulation, cash flows can be generated which will also be stochastic in nature. An optimization method can then be employed to minimize cash flow volatility by changing the amount or size of a currency hedge to employ over the user selected horizon.

### EXAMPLE 6

Optimal LIBOR Index

Ttax-exempt borrowers, as set forth above, often hedge tax-exempt floating rate bonds with LIBOR based interest rate swaps. However, given the relationship between tax-exempt rates and LIBOR, if the notional amount of the swap matches the amount of outstanding bonds (often required for tax or accounting purposes), the optimal percent age of LIBOR used to hedge the floating rate bonds is generally unknown. Based upon simulated market elements, an embodiment of the present invention may be configured to generate an expected cash flow distribution over the life of the swap and bonds. Such embodiments of the present invention can be configured to solve calculating borrower's objectives like minimizing the 95% highest net cash flow in the cash flow distribution. For instance, this may be achieved by configuring an embodiment of the present invention to generate expected distributions of LIBOR and tax-exempt short term rates through use of an interest rate model, using a cash flow model to translate those rate distributions into distributions of future cash flows, and then employing an optimization method to minimize the 95% highest net cash flow by changing the percent of LIBOR employed in the LIBOR based interest rate swap.

### EXAMPLE 7

Use of Adjustable Rate Bonds

A common, yet challenging, corporate finance question revolves around the degree of use of floating rate debt. Industry participants usually anticipate that floating rate debt, over time, will lead to lower overall debt capital cost. Companies also tend to hold a cash balance which effectively hedges a portion of floating interest expense. If a company has a specified risk tolerance, expressed by a desire to not exceed a certain interest expense net of interest earnings on cash balances, in any given year with 95% confidence the company might want to determine how much floating rate debt to employ while still keeping within that threshold. For instance, assuming LIBOR is a short term interest rate that drives the floating rate debt capital cost and the cash earnings, embodiments of the invention, according to the foregoing principles, may be configured to provide for an interest rate model to be employed to generate simulated stochastic interest rates. A cash low model is then used to map the simulated LIBOR rates into stochastic interest expense and cash earnings over the analytic horizon. A constrained optimization method can then be employed to determine the maximum amount of floating rate debt that may be used without exceeding the specified net interest expense target.

Assuming a company has entered into many different derivative contracts in order to manage risk. Given the current market, certain of these contracts are assets to the company, often “in the money”, and others are liabilities to the company, or referred to as being “out of the money”. Embodiments of the present invention say be configured to determine how to maximize the cash available from canceling certain of the “in the money” contracts while constraining or minimizing the amount of cash flow volatility introduced by unwinding the risk hedges. First, stochastic factors that drive cash flow volatility must be simulated using at least one interest rate model; e.g., one that is described in the foregoing, embodiments. Next, cash flows from debt, investments, and derivative contacts are generated from the simulation of the stochastic market elements. Once these are generated, an embodiment of the present invention configured according to the foregoing principles, provides for an optimization algorithm to be employed in order to select the contracts to be unwound which maximize the cash termination value but with the constraint that cashflow volatility not increase by a specified amount.

As described in some detail above, in sonic applications adding a sensitivity to mark to market changes may be implemented in alternate embodiments of the present invention, which may be considered as an enhancement by those whose objective is to include a more broad based risk management analysis which could include some measure of financial margin or financial spread as described above in example 3. Yet other embodiments of the present invention include financial margin, which may be implemented, without limitation, using multi-objective optimization methods in to weigh the cashflow objective function against the more traditional mark to market objective. It should be appreciated that, as mentioned to some degree previously, an embodiment of the present invention comprises the creation of full-fledged detailed cash flows at all applicable payment dates, wherein it is contemplated that as personal computing power increases this embodiment would become a preferred embodiment of the present invention. However, currently the tradeoffs between calculation speed and additional analytic insight seem to disfavor this approach.

Some embodiments of the present invention further include a value-added component which is a tool to calibrate the chosen interest rate model so that it does recover prices of swaps and caps for instance through the term of the model. In this way, the user has recovered market implied forward rates and volatilities. With this calibration complete, it will be evident to those skilled in the art that both traditional swaps and volatility based products such as caps and floors can be easily revalued within the optimization algorithm as described in more detail above.

Potential users of the invention include, but are not limited to, investment banks, financial advisers, and public finance issuers; likewise entities managing currency risks and corporate finance professionals who manage various types or cashflow risks. It is contemplated that further applicability of the present invention, or at least embodiments thereof, extends generally to individuals who might, for example, seek to explore the hedging effect of cash holdings against an adjustable rate mortgage.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of tie foregoing embodiments may be implemented using, any of a wide variety of suitable processes and system modules, and is not limited to any particular computer hardware, software, middleware, firmware, microcode and the like.

It will be further, apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of tie following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, execution of any subset of the foregoing method steps (e.g., without limitations execution of at least some the required novel calculations and models) may be performed and/or located outside of the jurisdiction of the USA while the remaining method steps (e.g., without limitations delivery of the calculation and model results to the user) and/or system components of the forgoing embodiments would be located/performed in the US for practical considerations.

Having fully described at least one embodiment of the present invention, other equivalent or alternative methods of determining optimal derivative structures and risk exposures according to the present invention is apparent to those skilled in the art. For example, without limitations although this invention has been described as a computer implemented process, manual implementations of the present invention, such as, without limitation the user manually perturbing the independent variable and recording the impact on the objective function, are also contemplated as within the scope of the present invention. An example of which includes, without limitations embodiments where a user employs the RiskMetrics CorporateManager software to manually recalculate Cash flow at Risk and determine the optimal structure by way of an iterative manual process. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method of analyzing a cashflow sensitive instrument, the method comprising the Steps of:
performing an optimization method on a data set associated with said cashflow sensitive instrument, said optimization method being based at least in part on an interest rate model and a cash-flow model, said interest rate model being at least partially based on at least one random variable used to simulate an underlying distribution of at least one interest rate; and
executing said optimization method to generate an optimal cashflow solution for the cashflow sensitive instrument(s), said optimal cashflow solution at least partially optimizing the factors of risk and/or cost.

2. The cashflow analyzing method of claim 1, in which said optimization method is unconstrained or constrained and at least in part based on one or more of sequential quadratic programming, nonlinear least-squares, least-squares, Linear programming, non-linear programming, genetic algorithm, Levenberg-Marquardt, or Gauss-Newton techniques.

3. The cashflow analyzing method of claim 1, in which said optimization method is at least partially used to change the amount of risk exposure or alter a derivative structure(s) to achieve certain objectives as at least partially defined by at least one objective function.

4. The cashflow analyzing, method of claim 3, in which a change in said at least one random variable results in a change to said at least one objective function and optionally to an at least one constraint function.

5. The cashflow analyzing method of claim 4, in which said at least one objective function comprises at least one measure of risk or cost.

6. The cashflow analyzing method of claim Error! Reference source not found., in which said at least one random variable is an independent variable and said at least one risk or cost measure is a dependent variable, where in a statistical distribution of the dependent variable is influenced by changes in one of said at least one independent variables.

7. The cashflow analyzing, method of claim 5, further comprising the Step of calculating, said at least one risk measure to estimate the variability of a statistical distribution associated within at least one of said at least one random variables.

8. The cashflow analyzing method of claim 1, in which said at least one random variable is a size of an exposure, a maturity, an amortization schedule, the fixed rate or floating, leg on an interest rate or currency swap or fixed or variable spread against the same, a basis swap rate or spread, a spread or multiplier rate on the floating leg of a swap, or a strike rate on any type of option.

9. The cashflow analyzing method of claim 1, further comprising the Step of creating a detailed cash flow analysis covering a certain range of applicable payment dates.

10. The cashflow analyzing method of claim 1, in which the term of said short-term interest rate is at most about 1 year in reset frequency.

11. The cashflow analyzing method of claim 1, in which at least one of said at least one interest rate affects a cashflow cost of liabilities and/or returns on at least one asset.

12. The cashflow analyzing method of claim 1, further comprising the Step of calculating distributions of variables that effect non-cashflow related returns.

13. The cashflow analyzing method of claim 12, in which the Step of calculating the distributions of variables further comprises the Step of calculating at least one expected covariance structure of various market elements.

14. The cashflow analyzing method of claim 1, further comprising the Step of calculating at least one diffusion input to simulate at least one distribution for at least one stochastic variable.

15. The cashflow analyzing method of claim 14, in which said at least one stochastic variable comprises at least one short term rate.

16. The cashflow analyzing method of claim 14, in which said diffusion input calculation Step generates a cash flow distribution by mapping existing or projected financial instruments and calculating a short-term interest rate.

17. The cashflow analyzing method of claim 1, in which the Step of simulating said underlying distribution is at least partially based on using a stochastic differential equation (SDE) for creating distributions of rates at particular point(s) in time.

18. The cashflow analyzing, method of claim 20, further comprising the Step of generating at least one distribution of market variables and a user mapping at least one of said distributions into an at least one distribution of cashflows.

19. The cashflow analyzing method of claim 1, in which said interest rate model is selected from the group of models consisting of equilibrium models, short-rate models, no-arbitrage models, Heath-Jarrow-Morton framework models, single factor models, multifactor models, positive-interest models, Markov models, market “fitting” models and market describing models.

20. The cashflow analyzing method of claim 1, further comprising the Step of using an implementation tool to effect said interest rate model.

21. The cashflow analyzing method of claim 17, in which said interest rate tool includes one or more of analytic forms, lattice methods, grid approaches, or monte-carlo methods.

22. The cashflow analyzing method of claim 1 further comprising the Step of modeling at least one asset return at least partially based on a covariance structure of the said at least one assets with said interest rate model.

23. The cashflow analyzing method of claim 22, in which the asset return modeling Step is at least partially based on the following model:
dSₜ=a(Sₜ,t)dt+b(Sₜ, t)dZₜ
where Sₜ is the asset, a( ) is a drift function through time, b( ) is a volatility term, and dZₜ is an increment of a standard Brownian motion.

24. The cashflow analyzing method of claim 1, in which said cashflow model is at least in part modeled according to the following equation for cash flows from an issuer:
$${C}_{t} = {P}_{t} + {\sum }_{i = i + 1}^{m} {P}_{i} {c}_{i} + {\sum }_{j = 1}^{n} {N}_{j} {f}_{j} ( {M}_{t} )$$
where Cₜ is cashflow at or during a budget time t, Pₜ is principal paid at or during time t, P is principal paid at times later than t, c are coupon rates paid on fixed or floating rate bonds prevailing at or during time t and N and ƒ are notional amounts and functions of market variables respectively.

25. The cashflow analyzing method of claim 24, further comprising the Step of calculating a traditional mark to market for at least one security as an additional term in said Cₜequation.

26. The cashflow analyzing method of claim 24, in which selection of said function ƒ is dependent of the type of cashflow sensitive instruments, whereby ƒ is respective defined for the following instrument types as:

| | |
|---|---|
| Floating rate bonds | fᵢ(M) = SR |
| Money market fund/cash | fᵢ(M) = −SR |
| Interest rate swap | fᵢ(M) = SwapRate − SR |
| Currency swap | fᵢ(M) = SR1 − SR2 |
| Cap | fᵢ(M) = max(0, SR − Strike) |
| Floor | fᵢ(M) = min(0, SR − Strike) |
| Tax-exempt Floaters | fᵢ(M) = BMA (+support costs) |
| BMA Swap | fᵢ(M) = SwapRate − BMA |
| LIBOR Swap | fᵢ(M) = SwapRate − LIBOR (or % LIBOR) |
| Basis Swap | fᵢ(M) = % LIBOR − BMA |
| BMA cap | fᵢ(M) = max(0, BMA − Strike) |
| BMA floor | fᵢ(M) = min(0, BMA − Strike) |
| Cash earnings | fᵢ(M) = LIBOR |

where SR is “short rate”, and BMA and LIBOR are any appropriate short term interest rates.

27. The cashflow analyzing method of claim 24, further comprising the Step of performing an at least one single or multi-objective optimization algorithm to solve for types or amounts of risk exposures that minimize a cumulative or periodic Cₜ Var[Cₜ], and/or other conventional statistical functions on Cₜ.

28. The cashflow analyzing method of claim 1, in which said financial instrument is a multi-period financial instrument.

29. A method of analyzing a cashflow sensitive instrument(s) comprising the Steps of:
simulating an underlying distribution of interest rates, said simulation being at least partially based on at least one random variable; and
executing, an optimization method to generate an optimal cashflow solution for the cashflow sensitive instrument(s), said optimal cashflow solution at least partially optimizing the factors of risk and/or cost.

30. A method of analyzing a cashflow sensitive instrument(s) comprising the Steps of:
performing an analysis algorithm that is at least in part based on using an interest rate model, a cash-flow model, and an optimization method;
simulating an underlying distribution of interest rates, said simulation being at least partially based on at least one random variable; and
executing said optimization method to generate an optimal cashflow solution for the cashflow sensitive instrument(s), said optimal cashflow solution at least partially optimizing the factors of risk and/or cost.

31. A method of analyzing a cashflow sensitive instrument, the method comprising:
Steps for analyzing a data set associated with said cashflow sensitive instrument; and
Steps for determining an optimal cashflow solution for the cash-flow sensitive instrument(s) that is at least partially based on said data set analysis.

32. The cashflow analyzing method of claim 31 , further comprising Steps for calculating said at least one risk measure to estimate the variability of a statistical distribution associated with at least one random variable.

33. The cash flow analyzing method of claim 31, further comprising the Step of creating a detailed cash flow analysis covering a certain range of applicable payment dates.

34. The cashflow analyzing method of claim 31, further comprising Steps for calculating distributions of variables that effect non-cashflow related returns.

35. The cashflow analyzing method of claim 34, in which the Steps for calculating the distributions of variables further comprises Steps for calculating at least one expected covariance structure of various market elements, said at least one expected covariance structure optionally being at least partially including a multivariate distribution.

36. The cashflow analyzing method of claim 31, further comprising Steps for calculating at least one diffusion input to simulate at least one distribution for at least one stochastic variable.

37. The cashflow analyzing, method of claim 31, further comprising Steps for generating at least one distribution of market variables and a user mapping at least one of said distributions into an at least one distribution of cashflows.

38. The cashflow analyzing method of claim 31, further comprising Steps for using an implementation tool to effect said interest rate model.

39. The cashflow analyzing method of claim 31, further comprising Steps for modeling at least one asset return at least partially based on a covariance structure of the said at least one assets with said interest rate model.

40. The cashflow analyzing method of claim 31, further comprising Steps for calculating a traditional mark to market for an at least one security.

41. The cashflow analyzing method of claim 31, further comprising Steps for performing an at least one single or multi-objective optimization algorithm to solve for types or amounts of risk exposures that minimize an at least one objective function.

42. The cash-flow analyzing method of claim 31, further comprising Steps for using a cost of capital constraint to generate the optimal risk/cost solution.

43. A computer program product for analyzing a cash-flow sensitive instrument, the program residing on a computer readable medium having a plurality of instructions stored thereon which, when executed by the processor, cause that processor to:
analyze a data set associated with said cashflow sensitive instrument and
determine an optimal cashflow solution for the cashflow sensitive instrument(s) that is at least partially based on said data set analysis.

44. The cashflow analyzing computer program product of claim 43, further comprising instructions for calculating said at least one risk measure to estimate the variability of a statistical distribution associated with at least one random variable.

45. The cashflow analyzing computer program product of claim 43, further comprising the Step of creating a detailed cash flow analysis covering a certain range of applicable payment dates.

46. The cashflow analyzing computer program product of claim 43, further comprising instructions for calculating distributions of variables that effect non-cashflow related returns.

47. The cashflow analyzing computer program product of claim 46, in which the instructions for calculating the distributions of variables further comprises instructions for calculating at least one expected covariance structure of various market elements.

48. The cashflow analyzing computer program product of claim 43, further comprising instructions for calculating at least one diffusion input to simulate at least one distribution for at least one stochastic variable.

49. The cashflow analyzing computer program product of claim 43, further comprising instructions for generating at least one distribution of market variables and a user mapping at least one of said distributions into an at least one distribution of cashflows.

50. The cashflow analyzing computer program product of claim 43, further comprising instructions for using an implementation tool to effect said interest rate model.

51. The cashflow analyzing computer program product of claim 43, further comprising instructions for modeling at least one asset returning at least partially based on a covariance structure of the said at least one assets with said interest rate model.

52. The cashflow analyzing computer program product of claim 43, further comprising instructions for performing an at least one single or multi-objective optimization algorithm to solve for types or amounts of risk exposures that minimize an at least one objective function.

53. The cashflow analyzing computer program product of claim 43, in which the computer-readable medium is one selected from the group consisting of a data signal embodied in a carrier wave, an optical disk, a hard disk, a floppy disk, a tape drive, a flash memory, and semiconductor memory.

54. A model for analyzing a cashflow sensitive instrument, the model comprising:
an optimization model of a data set associated with said cashflow sensitive instrument, said optimization model being based at least in part on an interest rate model and a cash-flow model, said interest rate model being at least partially based on at least one random variable used to simulate an underlying distribution of at least one interest rate;
a model output based on said optimization model, said model output outputting an optimal cashflow solution for the cashflow sensitive instrument(s), said optimal cashflow solution at least partially optimizing the factors of risk and/or cost.

55. The cashflow analyzing model of claim 54, in which said optimization model is unconstrained or constrained and at least in part based on one or more of sequential quadratic programming, nonlinear least-squares, least-squares, Linear program, non-linear programming, genetic algorithm, Levenberg-Marquardt, or Gauss-Newton techniques.

56. The cashflow analyzing model of claim 54, in which said optimization model is at least partially used to change the amount of risk exposure or alter a derivative structure(s) to achieve certain objectives as at least partially defined by at least one objective function.

57. The cashflow analyzing model of claim 54, in which said at least one objective function comprises at least one measure of risk or cost.

58. The cashflow analyzing model of claim Error! Reference source not found., further comprising a model for calculating said at least one risk measure to estimate the variability of a statistical distribution associated with at least one of said at least one random variables.

59. The cashflow analyzing model of claim 54, further comprising a model that uses at least one diffusion input to model at least one distribution for at least one stochastic variable.

60. The cashflow analyzing model of claim 54, in which said model for modeling said underlying distribution is at least partially based on using a stochastic differential equation (SDE) for creating distributions of rates at particular point(s) in time.

61. The cashflow analyzing, model of claim 54, further comprising a model for modeling at least one asset return at least partially based on a covariance structure of the said at least one assets with said interest rate model.

62. The cashflow analyzing model of claim 61, in which the asset return model is at least partially based on the following model:
dSₜ=a(Sₜ,t)dt+b(Sₜ,t)dZₜ
where Sₜ, is the asset, a( ) is a drift function through time, b( ) is a volatility term, and dZ₁ is an increment of a standard Brownian motion.

63. The cashflow analyzing model of claim 54, in which said cashflow model is at least in part modeled according to the following, equation for cash flows from an issuer:
$${C}_{t} = {P}_{t} + {\sum }_{i = t + 1}^{m} {P}_{i} {c}_{i} + {\sum }_{j = 1}^{n} {N}_{j} {f}_{j} ( {M}_{t} )$$
where Cₜ is cashflow at or during a budget time t, Pₜ is principal paid at or during time t, P is principal paid at times later than t, c are coupon rates paid on fixed or floating rate bonds prevailing at or during time t, and N and ƒ are notional amounts and functions of market variables respectively.

64. The cashflow analyzing model of claim 63, further comprising a model of a traditional mark to market for at least one security as an additional term in said Cₜ equation.

65. The cashflow analyzing model of claim 63, in which selection of said function ƒ is dependent of the type of cashflow sensitive instruments, whereby ƒ is respective defined for the following instrument types as:

| | |
|---|---|
| Floating rate bonds | fᵢ(M) = SR |
| Money market fund/cash | fᵢ(M) = −SR |
| Interest rate swap | fᵢ(M) = SwapRate − SR |
| Currency swap | fᵢ(M) = SR1 − SR2 |
| Cap | fᵢ(M) = max(0, SR − Strike) |
| Floor | fᵢ(M) = min(0, SR − Strike) |
| Tax-exempt Floaters | fᵢ(M) = BMA (+support costs) |
| BMA Swap | fᵢ(M) = SwapRate − BMA |
| LIBOR Swap | fᵢ(M) = SwapRate − LIBOR (or % LIBOR) |
| Basis Swap | fᵢ(M) = % LIB − BMA |
| BMA cap | fᵢ(M) = max(0, BMA − Strike) |
| BMA floor | fᵢ(M) = min(0, BMA − Strike) |
| Cash earnings | fᵢ(M) = LIBOR |

where SR is “short rate”, and BMA and LIBOR are any appropriate short term interest rates.

66. The cashflow analyzing model of claim 63, in which said model output it at least partially based on performing an at least one single or multi-objective optimization algorithm to solve for types or amounts of risk exposures that minimize a cumulative or periodic Ct, Var[Ct], and/or other conventional statistical functions on Ct.

67. A system for analyzing a cashflow sensitive instrument, the system comprising means for analyzing a data set associated with said cashflow sensitive instrument; and
means for determining an optimal cashflow solution for the cashflow sensitive instrument(s) that is at least partially based on said data set analysis.

68. The cashflow analyzing system of claim 67, further comprising means for performing an at least one single or multi-objective optimization algorithm to solve for types or amounts of risk exposures that minimize an at least one objective function.
